(19) United States
(12) Patent Application Publication
(10) Pub. No.: US 2018/0169968 A1
(43) Pub. Date: Jun. 21, 2018

(54) MULTI-DIMENSIONAL PRINTING SYSTEM AND METHOD

(71) Applicant: Michael Yearwood, Toronto (CA)

(72) Inventor: Michael Yearwood, Toronto (CA)

(21) Appl. No.: 15/385,619

(22) Filed: Dec. 20, 2016

(51) Int. Cl. B29C 67/00; B33Y 30/00; B33Y 10/00; B33Y 70/00

(52) U.S. Cl. CPC B29C 67/0059; B33Y 30/00; B29K 2105/0032; B33Y 70/00; B29C 67/0092; B33Y 10/00

(57) ABSTRACT

A multi-dimensional printing system including a method of making a three-dimensional object by solidifying a resin material. The system may include a liquid reservoir to hold a liquid resin and a drop-on-demand (ink-jet) print head configured to deposit a resin-modifying composition on a surface of the liquid resin. The resin-modifying composition may include a photoinitiator transforming the liquid resin into a radiation-curable composition when combined. A radiation-emitting source activates curing of the radiation-curable composition in the reservoir. A positioning member may be configured to supportively position the radiation-curable composition within the liquid resin after the curing. The positioning member may be configured to move cured portions of the radiation-curable composition downward to permit successive layers of the radiation-curable composition to be created and cured at the surface of the liquid resin. The system is further adaptable to provide two-dimensional printing functionality.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present system relates generally to the field of additive manufacturing and more specifically relates to manufacturing of three-dimensional [3D] objects by additive deposition, additive agglomeration, or additive layering using a projected-fluid process, the system further capable of two-dimensional printing of symbolic information.

### 2. Description of Related Art

3D printing refers to processes used to generate a three-dimensional object in which sequential layers of material are formed under computer control to create the object. The availability and use of 3D printing technology has increased steadily in the recent decades. Unfortunately, the rate at which current systems are able to produce objects is significantly slower than other production processes. Additional technical limitations, such as low printing resolution, has effectively restricted the use of the technology to prototyping, conceptual models, and similar design applications. Development of new 3D printing technologies having increased speed and printing resolution would benefit many. Furthermore, a single printing technology capable of producing both two-dimensional images and three-dimensional objects would be of significant value to many.

Attempts have been made to address the above-mentioned need, such as those found in U.S. Pub. No. 2016/0200044 to Voit et al., which relates to a cartridge-based 3D printing system. The described cartridge-based 3d printing system includes embodiments polymer resin from monomers or oligomers which floats on a dense liquid platform in which the curing occurs within a prepackaged vessel which facilitates the layer is printed at any given time. This art is representative of 3D printing devices, however, the speed and versatility of the Voit et al. apparatus is significantly limited. Moreover, none of the known prior art, taken either singly or in combination, is seen to describe the system as claimed.

### BRIEF SUMMARY OF THE INVENTION

In view of the foregoing disadvantages inherent in the known additive manufacturing art, the present disclosure provides a novel multi-dimensional printing system and method. The general purpose of the present disclosure, which will be described subsequently in greater detail, is to provide apparatus and methods directed to the generation of two-dimensional images and three-dimensional objects by solidifying a resin material.

A multi-dimensional printing system is disclosed herein. The multi-dimensional printing system includes a liquid reservoir configured to hold a liquid resin, a drop-on-demand print head configured to deposit at least one resin-modifying composition on a surface of the liquid resin contained within the liquid reservoir (the resin-modifying composition at least may include a photoinitiator transforming the liquid resin into a radiation-curable composition when combined), a radiation-emitting source configured to emit electromagnetic radiation may have a wavelength activating curing of the radiation-curable composition within the liquid reservoir, and a positioning member configured to supportively position the radiation-curable composition within the liquid resin after the curing. The positioning member may be locatable below a surface of the liquid resin and configured to move cured portions of the radiation-curable composition downward to permit successive layers of the radiation-curable composition to be created and cured at the surface of the liquid resin.

Moreover, it provides such a system wherein the drop-on-demand print head is configured to move relative to the liquid reservoir along a first axis and may be further configured to move relative to the liquid reservoir along a second axis. Movement of the second axis may be non-parallel with respect to the first axis. Also, the drop-on-demand print head implements at least one ink-jet process selected from a thermal-based process and a piezo-based process. In addition, it provides such a system wherein the drop-on-demand print head further includes at least one replaceable-cartridge receiver configured to removably receive at least one replaceable cartridge containing the resin-modifying composition. Moreover, the drop-on-demand print head may further include at least one inlet port adapted to receive a continuous supply of the resin-modifying composition.

Further, the radiation-emitting source may be configured to emit electromagnetic radiation having a wavelength in an ultraviolet band. Even further, the radiation-emitting source may be an electron-beam source. Moreover, the radiation-emitting source may include a plurality of emitters surrounding the surface of the liquid resin.

Additionally, the system may further include a controller at least configured to control the operation of the drop-on-demand print head and the positioning member. A control-data receiver configured to receive control data from at least one external data source may also be included.

Also, the system may further include at least one sheet tray configured to hold at least one sheet of printable material; wherein the system is configurable to enable the drop-on-demand print head to apply a two-dimensional image on the at least one sheet of printable material. In addition, further comprising the at least one resin-modifying composition. And, it provides such a system further comprising at least one replaceable cartridge containing the resin-modifying composition; and wherein the drop-on-demand print head includes at least one replaceable-cartridge receiver configured to removably receive the at least one replaceable cartridge. Further, it provides such a system wherein the at least one resin-modifying composition further includes at least one colorant configured to impart a color to the radiation-curable composition. Even further, it provides such a system further comprising the liquid resin. Even further, it provides such a system wherein the liquid resin includes at least one component selected from ceramics, metals, and bio-compatible compositions. Even further, it provides such a system further comprising a set of instructions; and wherein the system is arranged as a kit.

A method of using a multi-dimensional printing system is also disclosed herein. The method of using the multi-dimensional printing system may include the steps of: providing a liquid reservoir containing a liquid resin; depositing at least one resin-modifying composition on a surface of the liquid resin using at least one drop-on-demand print head, the resin-modifying composition at least may include a photoinitiator transforming the liquid resin into a radiation-curable composition when combined; curing the radiation-curable composition within the liquid reservoir using a radiation-emitting source configured to emit electromagnetic radiation may have a wavelength activating the curing process; and using a positioning member to supportively position the radiation-curable composition within the liquid resin after curing, the positioning member locatable below the surface of the liquid resin and configured to move cured portions of the radiation-curable composition downward to permit successive layers of the radiation-curable composition to be created and cured at the surface of the liquid resin. Even further, it provides such a method further comprising the steps of adding at least one colorant to the at least one resin-modifying composition to impart a color to the radiation-curable composition.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a multi-dimensional printing system and method, constructed and operative according to the teachings of the present disclosure.

FIG. 1 is a perspective view of a multi-dimensional printing system during an ‘in-use’ condition, according to an embodiment of the disclosure.

FIG. 2 is a perspective view of the multi-dimensional printing system, according to another embodiment of the present disclosure.

FIG. 3 is a diagrammatic cross-section view of the multi-dimensional printing system of FIG. 2, according to an embodiment of the present disclosure.

FIG. 4 is a diagrammatic cross-section view of an alternate print-head assembly of the multi-dimensional printing system of FIG. 2, according to an embodiment of the present disclosure.

FIG. 5 is a perspective view of the multi-dimensional printing system configured for 2D printing, according to an embodiment of the present disclosure.

FIG. 6 is a flow diagram illustrating a method of use for multi-dimensional printing system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an additive manufacturing process and more particularly to a multi-dimensional printing system and method as used to improve the manufacturing of three-dimensional [3D] objects by additive deposition, additive agglomeration, or additive layering.

Generally, the system produces a 3D object by spraying layers of a custom liquid activator formulation onto a resin wherein sequential layers are hardened by exposure to radiant energy. More specifically, the system may utilize at least one drop-on-demand process (also commonly referred to as an “ink-jet” process) to deposit colored pigments and a photo initiator onto a liquid resin surface, which is then hardened with Ultraviolet (UV) or other light. Each layer is similar to a 2D inkjet print. Taken together, all layers form at least one single object. In addition, and the liquid activator can be used to produce a two-dimensional printed image by modifying the apparatus to print into or onto a paper substrate producing a two-dimensional (2D) image.

The apparatus may utilize two or more print heads. The first may produce colors and black. The second may produce white and clear (for example, to produce windows or glass). With a single-layer printing capability of about 71290.18 square millimeters (about 215.9 millimeters by about 330.2 millimeters or about 8.5 inches by 13 inches) 70 times per minute, the presently disclosed device will be one of the world's fastest 3D printers. It is noted that increased operational capacities are envisioned. The color capability of the device is about 1 million colors per dot, each dot being 1/1200 cubic inch. The system requires no separate dust removal and curing stages. Also, no other 3D printer is adaptable as a regular office paper printer.

The system is unique in that the resin is kept separate from the photoinitiator and colorants until immediately after the inkjet sprays the liquid activator onto the resin. The liquid activator formulation requires a liquid medium, colorant, and between about 5 percent to 20 percent photoinitiator of the total. Colorant may be dye or pigment based. The composition does not contain any photo-reactive resin; rather, the liquid activator is sprayed onto the resin to generate a photo-reactive composition. The liquid activator does not begin curing in the container as other UV resins do. Thus, UV shielding of the resin container is not expressly required except to protect users from UV exposure. Exposure to UV or electron beam “(EB) solidifies the liquid activator composition that is in contact with the liquid resin, which sinks onto a support plate or build stage. A computer processor implements software code to slice a 3D model into a set of “pages”. A document processing software, such as Microsoft Word, may be used to assign a color to each pixel. As well as complex 3D printed objects, the device may be reconfigured to cover large-format applications, such as floors, cars, walls, counter tops, etc.

Inkjet technologies suitable for use in the present system include both thermal-based and piezo-based print heads. A set of 4.5 inch wide 2d print head modules produced by the print division of the Hewlett Packard Company may be modified and arranged in an array over the resin surface. This arrangement may allow 3D printing of the entire work surface width and depth with liquid activator in a single pass. A ceramic-based resin may be used with the system. The photoinitiator for the ceramic resin may be applied by the print heads. In one embodiment of the system, the resin may be replaced with a fluid compatible with the support of biological cells and the liquid activator may be replaced with biological cells, this machine may be used to 3D print biological tissues and complex structures (i.e., skin, livers, etc.)

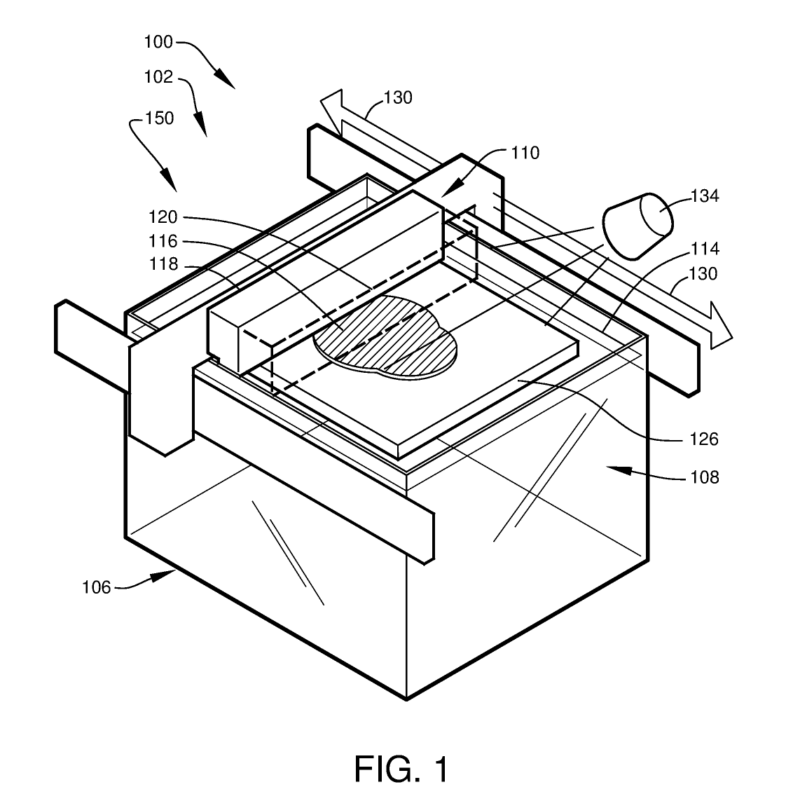

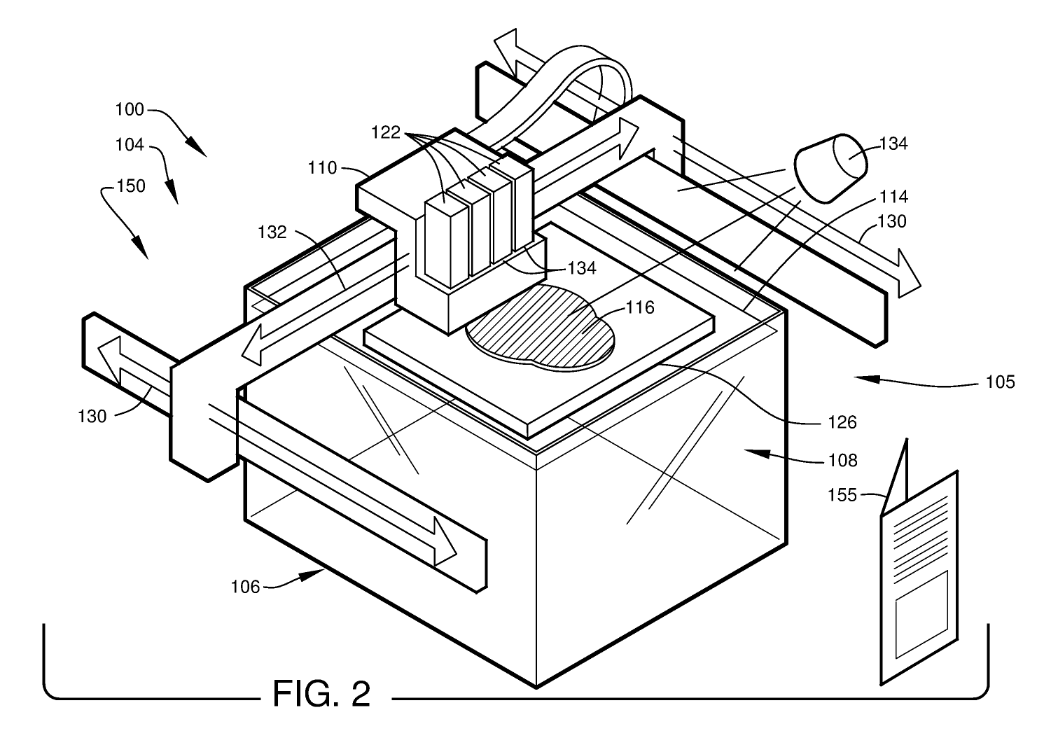

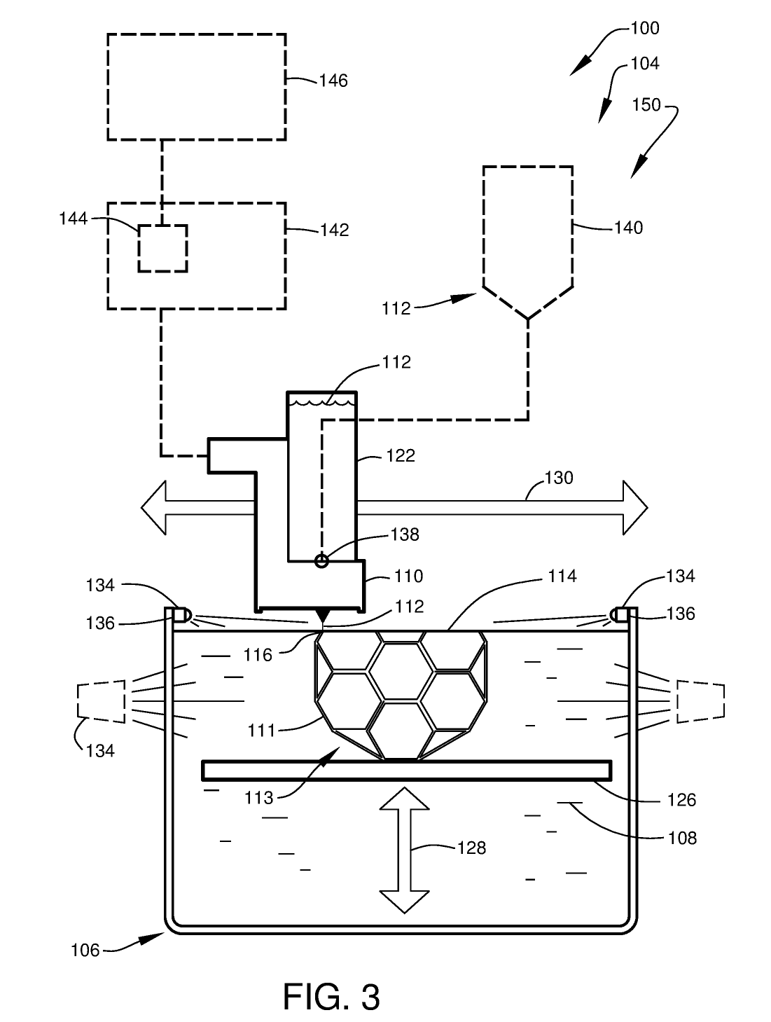

Referring now more specifically to the drawings by numerals of reference, there is shown in FIGS. 1-6, various embodiments of a multi-dimensional printing system 100. FIG. 1 shows a multi-dimensional printer 102 of the multi-dimensional printing system 100 during an ‘in-use’ condition 150, according to an embodiment of the present disclosure. FIG. 2 shows a front perspective view of an alternate multi-dimensional printer 104 of the multi-dimensional printing system 100 of FIG. 1, according to another embodiment of the present disclosure. FIG. 3 shows a cross section view of the multi-dimensional printing system 100 of FIG. 2. As illustrated, the embodiments of the multi-dimensional printing system 100 may include a liquid reservoir 106 containing a liquid resin 108 and a drop-on-demand (ink jet) print head 110 containing a set of micro-electro-mechanical nozzles configured to spray drops of a resin-modifying composition 112 on the surface 114 of the liquid resin 108 contained within the liquid reservoir 106.

TABLE 1
RESIN-MODIFYING COMPOSITION CONSTITUENTS
(LIQUID ACTIVATOR)

| | SECONDARY CONSTITUENTS |
|---|---|
| PRIMARY CONSTITUENTS | (Optional) |
| Liquid Carrier | Pigments/Colorants/Dyes |
| | (organic and inorganic) |
| Photoinitiator | Resins or Polymers |
| (about 5 percent to 20 | (to improve binding) |
| percent by volume) | |
| | Surfactants |
| | Dispersants |
| | Chemical Retardants/Accelerators |
| | Stabilizers |

Referring to TABLE 1, the resin-modifying composition 112 may at least include a liquid carrier combined with a photoinitiator, as shown. The resulting composition transforms the liquid resin 108 into a radiation-curable composition 116 when applied to the resin surface 114. The resin-modifying composition 112 may also include a colorant configured to impart a color to the radiation-curable composition 116. Depending on the selected resin and intended use, the resin-modifying composition 112 may include additional modifying constituents, as listed in the non-limiting examples of TABLE 1. Separating the photoinitiator from the resin allows the resin-modifying composition 112 to have the low viscosity required to interoperate with the ink-jet technology and is a key feature of the present system. Thus, print resolutions greater than 1200 dots per inch may be achieved with the present system.

The drop-on-demand print head 110 implements at least one ink-jet process selected from a thermal-based process, piezo-based process, or combinations of both. It is noted that the configuration and operation of such ink-jet process is described in greater detail in, for example, U.S. Pat. No. 4,490,728 to Vaught et al., incorporated herein by reference for further examples of implementation engineering.

The drop-on-demand print head 110 may include one or more print-head modules, each one managing the deposition of the resin-modifying composition 112. As an example, a first print-head module 118 may contain resin-modifying compositions 112 having black and primary color pigments or dyes. A second (optional) print-head module 120 (indicated in FIG. 1 by dashed-line depiction) may contain clear and white resin-modifying compositions 112. Those with ordinary skill in the art will now appreciate that upon reading this specification and by their understanding the art of ink-jet technology as described herein, a single print-head module containing black, primary color pigments, white, and clear resin-modifying compositions, may also be used.

As illustrated in FIG. 2, the drop-on-demand print head 110 may alternately utilize a group of replaceable cartridges 122, each one containing a differing resin-modifying composition 112. In this alternate configuration, the drop-on-demand print head 110 may include a set of replaceable-cartridge receivers 124, each one configured to removably receive at least one replaceable cartridge 122 containing the resin-modifying composition 112.

A positioning member in the form of a moveable stage 126 is provided to supportively position the radiation-curable composition 116 within the liquid resin 108 during and after the curing process. The stage 126 is locatable below the surface 114 of the liquid resin 108 and is configured to move cured portions 111 of the radiation-curable composition 116 downward during printing operations to permit successive layers of the radiation-curable composition 116 to be created and cured at the surface 114 of the liquid resin 108. In this manner, a printed 3D object 113 may be formed the liquid resin 108. The stage 126 is configured to move up and down along a substantially-vertical axis 128, as shown.

Referring to FIG. 1, the drop-on-demand print head 110 of the multi-dimensional printing system 100 is at least configured to move along a first axis 130 relative to the liquid reservoir 106. In this configuration, the drop-on-demand print head 110 may extend the full width of the stage 126, as shown. One example wide-format 2D print-head module that may adapted for use in the present system is produced by the Hewlett Packard Company within the PageWide® product line. It is noted that the configuration and operation of such wide-format 2D print-head devices are described in greater detail in, for example, U.S. Pat. No. 5,469,199 to Allen et al., incorporated herein by reference for further examples of implementation engineering.

Alternately, the drop-on-demand print head 110 may be configured to move along both the first axis 130 a second axis 132 oriented 90 degrees from the first axis 130, as generally shown in FIG. 2. The two-axis arrangement depicted in FIG. 2 allows the print head to move in linear, circular, or serpentine patterns, thus enabling the system to produce even larger-scale 2D and 3D outputs. It is noted that the drop-on-demand print head 110 and related mechanical actuators are generally isolated from the liquid reservoir 106 to limit vibrational disturbance of the liquid surface 114. It is further noted that the print head is kept level to the liquid surface 114 of the resin and at a specified height to control depth of penetration. This may be accomplished with an ultrasonic device or set of mechanical leveling screws. Those with ordinary skill in the art will now appreciate that upon reading this specification and by their understanding the present art, as described herein, methods of controlling the depth of penetration will be understood by those knowledgeable in such art.

In one embodiment of the present system, the range of movement of the drop-on-demand print head 110 is about 9 inches by about 13 inches, thus permitting full coverage of a 8.5-inch by 13-inch stage. Upon reading this specification, it should be appreciated that, under appropriate circumstances, considering such issues as user preferences, design preference, structural requirements, marketing preferences, cost, available materials, technological advances, etc., other system arrangements such as, for example, smaller formats, larger formats, alternate print head arrangements, etc., may be sufficient. For example, under appropriate circumstances, the system may be adapted to print on walls, floors, vehicle surfaces, etc., by spraying resin in a target surface followed by application of one or more resin-modifying compositions 112 from a mobile multi-axis ink-jet print head followed by UV curing. Additionally, use of a rotating print head mounted over a cylindrical reservoir, and spun about an axis (similar to a helicopter propeller), may 3D print without backlash from stopping the head.

A radiation-emitting source 134 may be provided to the cure radiation-curable composition 116. The radiation-emitting source 134 may be configured to emit electromagnetic radiation at a wavelength activating curing of the radiation-curable composition 116 located within the liquid reservoir 106. In one embodiment of the present system, the radiation-emitting source 134 is configured to emit light in the Ultraviolet (UV) spectrum. Moreover, the radiation-emitting source 134 may include a plurality of emitters 136 surrounding the surface 114 of the liquid resin 108, as best illustrated in FIG. 3. Alternately, the walls of the liquid reservoir 106 may be transparent allowing light produced by an external radiation-emitting source 134 to project through the walls to the interior of the liquid reservoir 106. Alternate embodiments of the present system may use an electron-beam (EB) emitter as the radiation-emitting source 134. Upon reading this specification, it should be appreciated that, under appropriate circumstances, considering such issues as user preferences, design preference, structural requirements, marketing preferences, cost, available materials, technological advances, etc., other curing arrangements such as, for example, lasers, radiant heat sources, non-photo-dependent chemical-based reactions, etc., may be sufficient.

In reference to FIG. 3, the drop-on-demand print head 110 may omit the print cartridges in favor of an inlet port 138 adapted to receive a continuous supply of the resin-modifying composition 112 from an external reservoir 140, as indicated by the dashed-line depiction. This alternate arrangement may be preferred in high-volume production environments where greater volumes of the resin-modifying composition 112 are required.

The system may further include a controller 142 at least configured to control the operation of the drop-on-demand print head 110 and the stage 126. A control-data receiver 144 configured to receive control data from at least one external data source 146 may also be included. The controller 142 may include a computer processor configured to implement software code used to slice a digital 3D model into a set of printable layers. Thus, motion may be controlled along the multiple axes described above. The position of the drop-on-demand print head 110 and the stage 126 may be driven by stepper motors or servo motors in order to provide highly accurate coordinated movements. For example, vertical movement of the stage 126 may be accomplished by rotation of threaded drive rods operably coupled to the stage 126 and rotationally driven by stepper motors located above the liquid reservoir 106.

Even further, the multi-dimensional printing system 100 may be supplied with a set of instructions 155 and wherein the system is arranged as a kit 105. The instructions may detail functional relationships in relation to the structure of the multi-dimensional printing system 100 (such that the multi-dimensional printing system 100 can be used, maintained, or the like, in a preferred manner).

The kit 105 may further include the liquid resin 108. Depending on the application, the liquid resin 108 may be clear, translucent, or a color appropriate to the object being generated. The liquid resin 108 may include a range of material chemistries not limited to Acrylates, rigid Polyurethanes, flexible Polyurethanes, elastomeric Polyurethanes, Cyanate Esters, etc. In addition, the system may include specialty resins containing ceramics and metals. Upon reading this specification, it should be appreciated that, under appropriate circumstances, considering such issues as user preferences, design preference, structural requirements, marketing preferences, cost, available materials, technological advances, etc., other resin arrangements such as, for example, bio-compatible compositions, etc., may be sufficient.

FIG. 4 shows a side view of an alternate arrangement of the multi-dimensional printing system 100 of FIG. 1. As above, the multi-dimensional printing system 100 may include the drop-on-demand print head 110, as shown. In the present example, the radiation-emitting source 134 has been incorporated into the moving drop-on-demand print head 110. This arrangement may be preferred when rapid curing methods are employed, for example, curing the resin using a high-energy laser. Upon reading this specification, it should be appreciated that, under appropriate circumstances, considering such issues as user preferences, design preference, structural requirements, marketing preferences, cost, available materials, technological advances, etc., other system arrangements such as, for example, arranging the apparatus to print clothing, arranging the apparatus to print biological tissues (muscle tissue, skin, kidneys, cartilage, bones, etc.), adding one or more resin components to the ink-jetted compositions and substituting the resin for salt water or other liquid substrate, etc., may be sufficient.

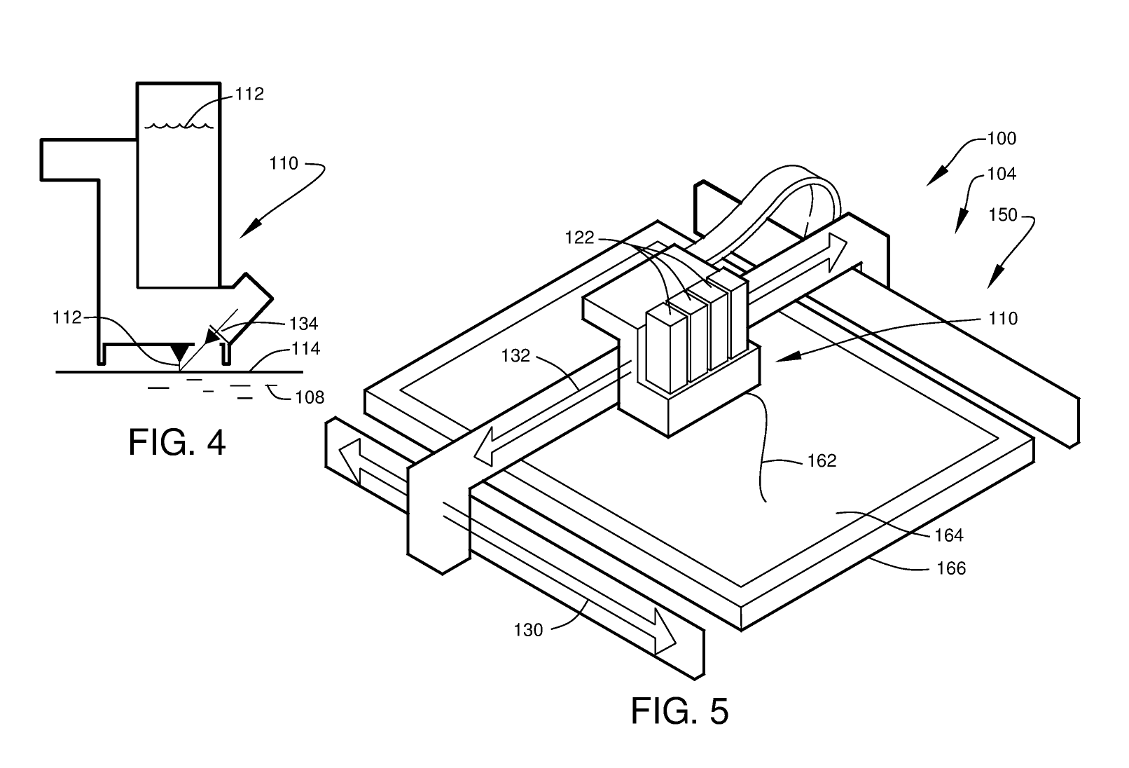

FIG. 5 shows a front perspective view of the alternate multi-dimensional printer 104 of FIG. 1 reconfigured for 2D printing, according to another embodiment of the present disclosure. The system may be configurable to enable the drop-on-demand print head 110 to apply a two-dimensional image 162 on the surface of a printable material 164. In this alternate configuration, the liquid reservoir 106 of FIG. 2 may be replaced with a sheet tray 166 configured to hold at least one sheet of the printable material 164. The sheet tray 166 is raised to the drop-on-demand print head 110, which jets ink onto the printable material 164, as shown. After printing, the printable material 164 is extracted and may be passed to a storage bin or otherwise processed in a manner customary in reprographic sheet handling procedures.

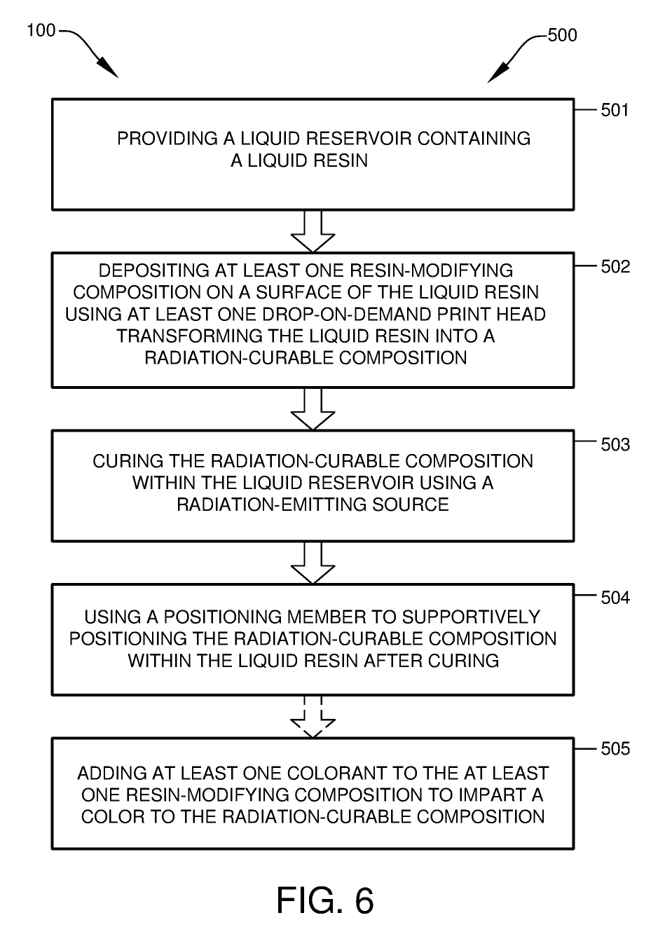

FIG. 6 is a flow diagram illustrating a method of making a three-dimensional object by solidifying a resin material 500, according to an embodiment of the present disclosure. As illustrated, the method of making a three-dimensional object by solidifying a resin material 500 may include the steps of: step one 501, providing a liquid reservoir containing a liquid resin; step two 502, depositing at least one resin-modifying composition on a surface of the liquid resin using at least one drop-on-demand print head, the resin-modifying composition at least may include a photoinitiator transforming the liquid resin into a radiation-curable composition when combined; step three 503, curing the radiation-curable composition within the liquid reservoir using a radiation-emitting source configured to emit electromagnetic radiation may have a wavelength activating the curing process; and step four 504, using a positioning member to supportively position the radiation-curable composition within the liquid resin after curing, the positioning member locatable below the surface of the liquid resin and configured to move cured portions of the radiation-curable composition downward to permit successive layers of the radiation-curable composition to be created and cured at the surface of the liquid resin. Even further, it provides such a method further comprising the step of; step five 505, adding at least one colorant to the at least one resin-modifying composition to impart a color to the radiation-curable composition.

It should be noted that step 505 is an optional step and may not be implemented in all cases. Optional steps of method of use 500 are illustrated using dotted lines in FIG. 6 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for multi-dimensional printing system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A three-dimensional printing system, the system comprising:
a liquid reservoir configured to hold a liquid resin;
a drop-on-demand print head configured to deposit at least one resin-modifying composition on a surface of the liquid resin contained within the liquid reservoir, the resin-modifying composition at least including a photoinitiator transforming the liquid resin into a radiation-curable composition when combined;
a radiation-emitting source configured to emit electromagnetic radiation having a wavelength activating curing of the radiation-curable composition within the liquid reservoir; and
a positioning member configured to supportively position the radiation-curable composition within the liquid resin after the curing, the positioning member locatable below a surface of the liquid resin and configured to move cured portions of the radiation-curable composition downward to permit successive layers of the radiation-curable composition to be created and cured at the surface of the liquid resin.

2. The system of claim 1, wherein the drop-on-demand print head is configured to move relative to the liquid reservoir along a first axis.

3. The system of claim 2, wherein
the drop-on-demand print head is further configured to move relative to the liquid reservoir along a second axis, and
movement of the second axis is non-parallel with respect to the first axis.

4. The system of claim 1, wherein the drop-on-demand print head implements at least one ink-jet process selected from a thermal-based process and a piezo-based process.

5. The system of claim 1, wherein the drop-on-demand print head further comprises at least one replaceable-cartridge receiver configured to removably receive at least one replaceable cartridge containing the resin-modifying composition.

6. The system of claim 1, wherein the drop-on-demand print head further comprises at least one inlet port adapted to receive a continuous supply of the resin-modifying composition.

7. The system of claim 1, wherein the radiation-emitting source is configured to emit electromagnetic radiation having a wavelength in an ultraviolet band.

8. The system of claim 1, wherein the radiation-emitting source is an electron-beam source.

9. The system of claim 1, wherein the radiation-emitting source comprises a plurality of emitters surrounding the surface of the liquid resin.

10. The system of claim 1, further comprising
a controller at least configured to control the operation of the drop-on-demand print head and the positioning member; and
a control-data receiver configured to receive control data from at least one external data source.

11. The system of claim 1, further comprising
at least one sheet tray configured to hold at least one sheet of printable material;
wherein the system is configurable to enable the drop-on-demand print head to apply a two-dimensional image on the at least one sheet of printable material.

12. The system of claim 1, further comprising the at least one resin-modifying composition.

13. The system of claim 12, further comprising
at least one replaceable cartridge containing the resin-modifying composition; and
wherein the drop-on-demand print head comprises at least one replaceable-cartridge receiver configured to removably receive the at least one replaceable cartridge.

14. The system of claim 12, wherein the at least one resin-modifying composition further comprises at least one colorant configured to impart a color to the radiation-curable composition.

15. The system of claim 1, further comprising the liquid resin.

16. The system of claim 15, wherein the liquid resin includes at least one component selected from ceramics and metals.

17. A three-dimensional printing system, the system comprising:
a liquid resin;
a liquid reservoir configured to hold the liquid resin;
a resin-modifying composition, the resin-modifying composition at least including a photoinitiator transforming the liquid resin into a radiation-curable composition when combined;
at least one replaceable cartridge containing the resin-modifying composition;
a drop-on-demand print head configured to deposit at least one resin-modifying composition on a surface of the liquid resin contained within the liquid reservoir;
a radiation-emitting source configured to emit electromagnetic radiation having a wavelength activating curing of the radiation-curable composition within the liquid reservoir; and
a positioning member configured to supportively position the radiation-curable composition within the liquid resin after the curing, the positioning member locatable below the surface of the liquid resin and configured to move cured portions of the radiation-curable composition downward to permit successive layers of the radiation-curable composition to be created and cured at the surface of the liquid resin;
wherein the drop-on-demand print head and the liquid reservoir are configured to move relative to each other along a first axis;
wherein the drop-on-demand print head; and the liquid reservoir are configured to move relative to each other along a second axis;
wherein the movement of the second axis is non-parallel with respect to the first axis;
wherein the drop-on-demand print head implements at least one ink-jet process selected from a thermal-based process and a piezo-based process;
wherein the drop-on-demand print head further comprises at least one cartridge receiver configured to removably receive the at least one replaceable cartridge containing the resin-modifying composition;
wherein the radiation-emitting source is selected from a source configured to emit electromagnetic radiation having a wavelength in the ultraviolet band;
wherein the system further comprises
a controller at least configured to control the operation of the drop-on-demand print head and the positioning member,
a control-data receiver configured to receive control data from at least one external data source, and
at least one sheet tray configured to hold at least one sheet of printable material, wherein the system is configurable to enable the drop-on-demand print head to apply a two-dimensional image on the at least one sheet of printable material; and
wherein the at least one resin-modifying composition further comprises at least one colorant configured to impart a color to the radiation-curable composition.

18. The system of claim 17, further comprising a set of instructions; and
wherein the system is arranged as a kit.

19. A method of making a three-dimensional object by solidifying a resin material, the method comprising the steps of:
providing a liquid reservoir containing a liquid resin;
depositing at least one resin-modifying composition on a surface of the liquid resin using at least one drop-on-demand print head, the resin-modifying composition at least including a photoinitiator transforming the liquid resin into a radiation-curable composition when combined;
curing the radiation-curable composition within the liquid reservoir using a radiation-emitting source configured to emit electromagnetic radiation having a wavelength activating the curing process; and
using a positioning member to supportively position the radiation-curable composition within the liquid resin after curing, the positioning member locatable below the surface of the liquid resin and configured to move cured portions of the radiation-curable composition downward to permit successive layers of the radiation-curable composition to be created and cured at the surface of the liquid resin.

20. The method of claim 19, further comprising the steps of adding at least one colorant to the at least one resin-modifying composition to impart a color to the radiation-curable composition.
